(19) United States
(12) Patent Application Publication
(10) Pub. No.: US 2008/0001724 A1
(43) Pub. Date: Jan. 3, 2008

(54) Using read lock capability for secure RFID authentication

(75) Inventors: Mohammad Soleimani, Gaithersburg, MD (US); Joseph White, Woodbine, MD (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Symbol Technologies, Inc., Holtsville, NY (US)

(21) Appl. No.: 11/495,673

(22) Filed: Jul. 31, 2006

Related U.S. Application Data
(60) Provisional application No. 60/816,864, filed on Jun. 28, 2006.

(51) Int. Cl. H04Q 5/22

(52) U.S. Cl. 340/10.51; 340/10.1; 340/572.1; 340/5.61; 340/5.74

(57) ABSTRACT

Methods, systems, and apparatuses for preventing unauthorized reading of identifying data stored in tags are described. A secure access identification number and associated read lock password are received. The secure access identification number and associated read lock passcode are transferred to the tag. The tag stores the secure access identification number and read lock passcode. A read lock command is transmitted to the tag. The tag is locked from being read for selected information, such as identifying information and user information, by the read lock command. In a further aspect, the secure access identification number is read from the read locked tag. The secure access identification number is associated with a passcode. The passcode is transmitted to the read locked tag. The tag disables the read lock if the passcode matches the previously received read lock password.

### CROSS-REFERENCE TO RELATED APPLICATIONS

The present application claims the benefit of U.S. Appl. No. 60/816,864, filed Jun. 28, 2006, which is incorporated by reference herein in its entirety

The following pending application of common assignee is related to the present application, has the same filing date as the present application, and is herein incorporated by reference in its entirety:

“Read Locking Of An RFID Tag,” Atty. Dkt. No. 2319.0810001, U.S. Appl. No. TBA.

### BACKGROUND OF THE INVENTION

1. Field of the Invention

The present invention relates to wireless communications, and more particularly, to radio frequency identification (RFID) communication systems and protocols for communications between RFID readers and RFID tags.

2. Background Art

Radio frequency identification (RFID) tags are electronic devices that may be affixed to items whose presence is to be detected and/or monitored. The presence of an RFID tag, and therefore the presence of the item to which the tag is affixed, may be checked and monitored wirelessly by devices known as “readers.” Readers typically have one or more antennas transmitting radio frequency signals to which tags respond. Since the reader “interrogates” RFID tags, and receives signals back from the tags in response to the interrogation, the reader is sometimes termed as “reader interrogator” or simply “interrogator”.

In a RFID system, typically a reader transmits a continuous wave (CW) or modulated radio frequency (RF) signal to a tag. The tag receives the signal, and responds by modulating the signal, “backscattering” an information signal to the reader. The reader receives signals back from the tag, and the signals are demodulated, decoded and further processed.

With the maturation of RFID technology, efficient communications between tags and readers has become a key enabler in supply chain management, especially in manufacturing, shipping, and retail industries, as well as in building security installations, healthcare facilities, libraries, airports, warehouses etc.

In many application of RFID, such as pharmaceuticals, defense, and border control, it is desired protect information embedded in tags from being obtained by unauthorized readers. Thus, what is needed are improved ways of maintaining security and/or privacy for data in tags.

### BRIEF SUMMARY OF THE INVENTION

Methods, systems, and apparatuses for preventing unauthorized reading of data stored in tags are described. An RFID communications device (e.g., a reader) is used to communicate with a RFID tag to cause the tag to enter a read lock state. In the read lock state, the tag cannot be read for designated information, such as identifying information and/or user information stored in the tag. A secure access identification number can be used to determine a password for the tag, to subsequently disable the read lock state.

In an aspect, a secure access identification number and associated read lock passcode are transferred to a tag. The tag stores the secure access identification number and read lock passcode. A read lock command is transmitted to the tag. The tag is locked from being read for selected information, such as identifying information and user information, by the read lock command.

In a further aspect, the secure access identification number is read from the read locked tag. The read secure access identification number is associated with a passcode.

The passcode is transmitted to the read locked tag. The tag removes the read lock if the passcode matches the read lock password stored by the tag.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows an environment where RFID readers communicate with an exemplary population of RFID tags.

FIG. 2 shows a block diagram of receiver and transmitter portions of an RFID reader.

FIG. 3 shows a block diagram of an example radio frequency identification (RFID) tag.

FIG. 4 shows a logical representation of memory in an example Gen 2-type RFID tag.

FIG. 5 shows further detail of memory bank in a Gen 2-type tag.

FIG. 6 shows a reader, according to an example embodiment of the present invention.

FIG. 7 shows a tag, according to an example embodiment of the present invention.

FIGS. 8-10 show example communications between readers and tags, according to embodiments of the present invention.

FIG. 11 shows an example communication between a reader and secure database, according to embodiments of the present invention.

FIG. 12 shows an example flowchart for a tag, according to an embodiment of the present invention.

FIG. 13 shows an example flowchart for a reader, according to an embodiment of the present invention.

FIG. 14BA shows a tag, according to an example embodiment of the present invention.

FIG. 14B shows a system for securing data on a tag, according to an example embodiment of the present invention.

FIG. 15 shows a ladder diagram providing additional detail for an example implementation of the system of FIG. 14B, according to an embodiment of the present invention.

FIG. 16 shows a flowchart for a reader to configure a tag for read security, according to an example embodiment of the present invention.

FIG. 17 shows a flowchart for a tag to be configured for read security by a reader, according to an example embodiment of the present invention.

FIG. 18 shows a system for communicating with a read locked tag, according to an example embodiment of the present invention.

FIG. 19 shows a ladder diagram providing additional detail for an example implementation of the system of FIG. 18, according to an embodiment of the present invention.

FIG. 20 shows a flowchart for a reader to communicate with a tag in a read lock condition, according to an example embodiment of the present invention.

FIG. 21 shows a flowchart for communicating with a tag, according to an example embodiment of the present invention.

FIG. 22 shows a pharmaceutical environment implementing read security, according to example embodiment of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

Methods, systems, and apparatuses for preventing unwanted read access to data stored in tags, and for communicating with tags that are in a read lock condition, are described. The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Likewise, particular bit values of “0” or “1” (and representative voltage values) are used in illustrative examples provided herein to represent data for purposes of illustration only.

Data described herein can be represented by either bit value (and by alternative voltage values), and embodiments described herein can be configured to operate on either bit value (and any representative voltage value), as would be understood by persons skilled in the relevant art(s).

### Example RFID System Embodiment

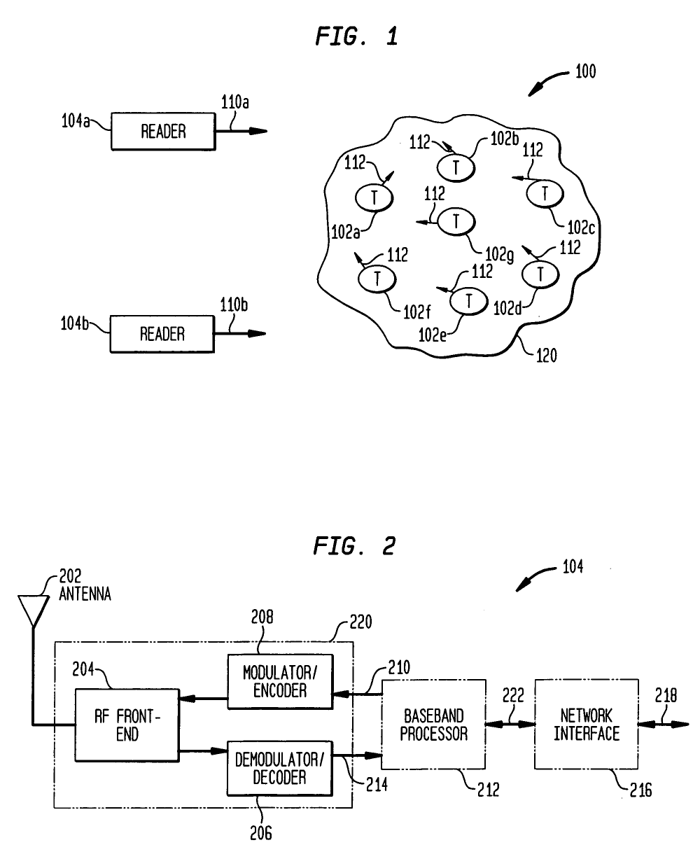

Before describing embodiments of the present invention in detail, it is helpful to describe an example RFID communications environment in which the invention may be implemented. FIG. 1 illustrates an environment 100 where RFID tag readers 104 communicate with an exemplary population 120 of RFID tags 102. As shown in FIG. 1, the population 120 of tags includes seven tags 102a-102g. A population 120 may include any number of tags 102.

Environment 100 includes any number of one or more readers 104. For example, environment 100 includes a first reader 104a and a second reader 104b. Readers 104a and/or 104b may be requested by an external application to address the population of tags 120. Alternatively, reader 104a and/or reader 104b may have internal logic that initiates communication, or may have a trigger mechanism that an operator of a reader 104 uses to initiate communication. Readers 104a and 104b may also communicate with each other in a reader network.

As shown in FIG. 1, reader 104a transmits an interrogation signal 110 having a carrier frequency to the population of tags 120. Reader 104b transmits an interrogation signal 110b having a carrier frequency to the population of tags 120. Readers 104a and 104b typically operate in one or more of the frequency bands allotted for this type of RF communication. For example, frequency bands of 902-928 MHz and 2400-2483.5 MHz have been defined for certain RFID applications by the Federal Communication Commission (FCC).

Various types of tags 102 may be present in tag population 120 that transmit one or more response signals 112 to an interrogating reader 104, including by alternatively reflecting and absorbing portions of signal 110 according to a time-based pattern or frequency. This technique for alternatively absorbing and reflecting signal 110 is referred to herein as backscatter modulation. Readers 104a and 104b receive and obtain data from response signals 112, such as an identification number of the responding tag 102. In the embodiments described herein, a reader may be capable of communicating with tags 102 according to any suitable communication protocol, including Class 0, Class 1, EPC Gen 2, other binary traversal protocols and slotted aloha protocols, any other protocols mentioned elsewhere herein, and future communication protocols.

FIG. 2 shows a block diagram of an example RFID reader 104. Reader 104 includes one or more antennas 202, a receiver and transmitter portion 220 (also referred to as transceiver 220), a baseband processor 212, and a network interface 216. These components of reader 104 may include software, hardware, and/or firmware, or any combination thereof, for performing their functions.

Baseband processor 212 and network interface 216 are optionally present in reader 104. Baseband processor 212 may be present in reader 104, or may be located remote from reader 104. For example, in an embodiment, network interface 216 may be present in reader 104, to communicate between transceiver portion 220 and a remote server that includes baseband processor 212. When baseband processor 212 is present in reader 104, network interface 216 may be optionally present to communicate between baseband processor 212 and a remote server. In another embodiment, network interface 216 is not present in reader 104.

In an embodiment, reader 104 includes network interface 216 to interface reader 104 with a communications network 218. As shown in FIG. 2, baseband processor 212 and network interface 216 communicate with each other via a communication link 222. Network interface 216 is used to provide an interrogation request 210 to transceiver portion 220 (optionally through baseband processor 212), which may be received from a remote server coupled to communications network 218. Baseband processor 212 optionally processes the data of interrogation request 210 prior to being sent to transceiver portion 220. Transceiver 220 transmits the interrogation request via antenna 202.

Reader 104 has at least one antenna 202 for communicating with tags 102 and/or other readers 104. Antenna(s) 202 may be any type of reader antenna known to persons skilled in the relevant art(s), including a vertical, dipole, loop, Yagi-Uda, slot, or patch antenna type. For description of an example antenna suitable for reader 104, refer to U.S. Ser. No. 11/265,143, filed Nov. 3, 2005, titled “Low Return Loss Rugged RFID Antenna,” now pending, which is incorporated by reference herein in its entirety.

Transceiver 220 receives a tag response via antenna 202. Transceiver 220 outputs a decoded data signal 214 generated from the tag response. Network interface 216 is used to transmit decoded data signal 214 received from transceiver portion 220 (optionally through baseband processor 212) to a remote server coupled to communications network 218. Baseband processor 212 optionally processes the data of decoded data signal 214 prior to being sent over communications network 218.

In embodiments, network interface 216 enables a wired and/or wireless connection with communications network 218. For example, network interface 216 may enable a wireless local area network (WLAN) link (including a IEEE 802.11 WLAN standard link), a BLUETOOTH link, and/or other types of wireless communication links. Communications network 218 may be a local area network (LAN), a wide area network (WAN) (e.g., the Internet), and/or a personal area network (PAN).

In embodiments, a variety of mechanisms may be used to initiate an interrogation request by reader 104. For example, an interrogation request may be initiated by a remote computer system/server that communicates with reader 104 over communications network 218. Alternatively, reader 104 may include a finger-trigger mechanism, a keyboard, a graphical user interface (GUI), and/or a voice activated mechanism with which a user of reader 104 may interact to initiate an interrogation by reader 104.

In the example of FIG. 2, transceiver portion 220 includes a RF front-end 204, a demodulator/decoder 206, and a modulator/encoder 208. These components of transceiver 220 may include software, hardware, and/or firmware, or any combination thereof, for performing their functions. Example description of these components is provided as follows.

Modulator/encoder 208 receives interrogation request 210, and is coupled to an input of RF front-end 204. Modulator/encoder 208 encodes interrogation request 210 into a signal format, modulates the encoded signal, and outputs the modulated encoded interrogation signal to RF front-end 204. For example, pulse-interval encoding (PIE) may be used in a Gen 2 embodiment. Furthermore, double sideband amplitude shift keying (DSB-ASK), single sideband amplitude shift keying (SSB-ASK), or phase-reversal amplitude shift keying (PR-ASK) modulation schemes may be used in a Gen 2 embodiment. Note that in an embodiment, baseband processor 212 may alternatively perform the encoding function of modulator/encoder 208.

RF front-end 204 may include one or more antenna matching elements, amplifiers, filters, an echo-cancellation unit, a down-converter, and/or an up-converter. RF front-end 204 receives a modulated encoded interrogation signal from modulator/encoder 208, up-converts (if necessary) the interrogation signal, and transmits the interrogation signal to antenna 202 to be radiated. Furthermore, RF front-end 204 receives a tag response signal through antenna 202 and down-converts (if necessary) the response signal to a frequency range amenable to further signal processing.

Demodulator/decoder 206 is coupled to an output of RF front-end 204, receiving a modulated tag response signal from RF front-end 204. In an EPC Gen 2 protocol environment, for example, the received modulated tag response signal may have been modulated according to amplitude shift keying (ASK) or phase shift keying (PSK) modulation techniques. Demodulator/decoder 206 demodulates the tag response signal. For example, the tag response signal may include backscattered data formatted according to FMO or Miller encoding formats in an EPC Gen 2 embodiment. Demodulator/decoder 206 outputs decoded data signal 214. Note that in an embodiment, baseband processor 212 may alternatively perform the decoding function of demodulator/decoder 206.

The configuration of transceiver 220 shown in FIG. 2 is provided for purposes of illustration, and is not intended to be limiting. Transceiver 220 may be configured in numerous ways to modulate, transmit, receive, and demodulate RFID communication signals, as would be known to persons skilled in the relevant art(s).

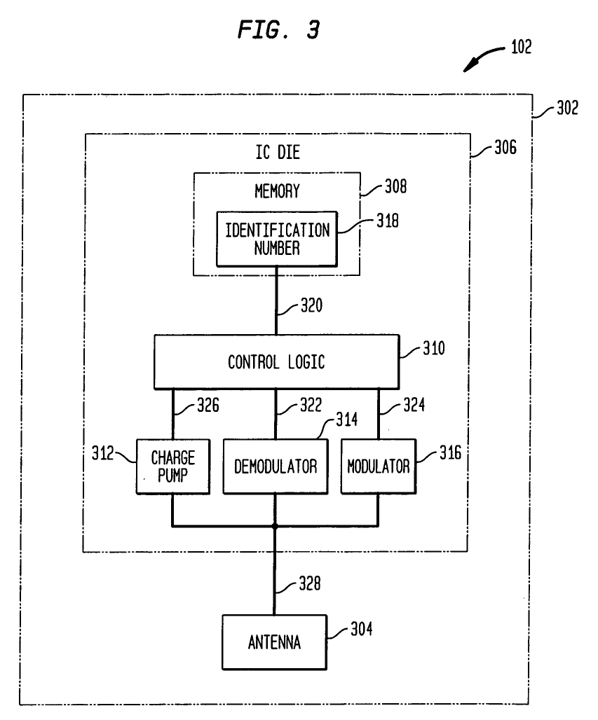

The present invention is applicable to any type of RFID tag. FIG. 3 shows a plan view of an example radio frequency identification (RFID) tag 102. Tag 102 includes a substrate 302, an antenna 304, and an integrated circuit (IC) 306. Antenna 304 is formed on a surface of substrate 302. Antenna 304 may include any number of one, two, or more separate antennas of any suitable antenna type, including dipole, loop, slot, or patch antenna type. IC 306 includes one or more integrated circuit chips/dies, and can include other electronic circuitry. IC 306 is attached to substrate 302, and is coupled to antenna 304. IC 306 may be attached to substrate 302 in a recessed and/or non-recessed location.

IC 306 controls operation of tag 102, and transmits signals to, and receives signals from RFID readers using antenna 304. In the example embodiment of FIG. 3, IC 306 includes a memory 308, a control logic 310, a charge pump 312, a demodulator 314, and a modulator 316. An input of charge pump 312, an input of demodulator 314, and an output of modulator 316 are coupled to antenna 304 by antenna signal 328. Note that in the present disclosure, the terms “lead” and “signal” may be used interchangeably to denote the connection between elements or the signal flowing on that connection.

Memory 308 is typically a non-volatile memory, but can alternatively be a volatile memory, such as a DRAM. Memory 308 stores data, including an identification number 318. Identification number 318 typically is a unique identifier (at least in a local environment) for tag 102. For instance, when tag 102 is interrogated by a reader (e.g., receives interrogation signal 110 shown in FIG. 1), tag 102 may respond with identification number 318 to identify itself. Identification number 318 may be used by a computer system to associate tag 102 with its particular associated object/item.

Demodulator 314 is coupled to antenna 304 by antenna signal 328. Demodulator 314 demodulates a radio frequency communication signal (e.g., interrogation signal 110) on antenna signal 328 received from a reader by antenna 304. Control logic 310 receives demodulated data of the radio frequency communication signal from demodulator 314 on input signal 322. Control logic 310 controls the operation of RFID tag 102, based on internal logic, the information received from demodulator 314, and the contents of memory 308. For example, control logic 310 accesses memory 308 via a bus 320 to determine whether tag 102 is to transmit a logical “1” or a logical “0” (of identification number 318) in response to a reader interrogation. Control logic 310 outputs data to be transmitted to a reader (e.g., response signal 112) onto an output signal 324. Control logic 310 may include software, firmware, and/or hardware, or any combination thereof. For example, control logic 310 may include digital circuitry, such as logic gates, and may be configured as a state machine in an embodiment.

Modulator 316 is coupled to antenna 304 by antenna signal 328, and receives output signal 324 from control logic 310. Modulator 316 modulates data of output signal 324 (e.g., one or more bits of identification number 318) onto a radio frequency signal (e.g., a carrier signal transmitted by reader 104) received via antenna 304. The modulated radio frequency signal is response signal 112, which is received by reader 104. In an embodiment, modulator 316 includes a switch, such as a single pole, single throw (SPST) switch. The switch changes the return loss of antenna 304. The return loss may be changed in any of a variety of ways. For example, the RF voltage at antenna 304 when the switch is in an “on” state may be set lower than the RF voltage at antenna 304 when the switch is in an “off” state by a predetermined percentage (e.g., 30 percent). This may be accomplished by any of a variety of methods known to persons skilled in the relevant art(s).

Charge pump 312 is coupled to antenna 304 by antenna signal 328. Charge pump 312 receives a radio frequency communication signal (e.g., a carrier signal transmitted by reader 104) from antenna 304, and generates a direct current (DC) voltage level that is output on a tag power signal 326. Tag power signal 326 is used to power circuits of IC die 306, including control logic 320.

In an embodiment, charge pump 312 rectifies the radio frequency communication signal of antenna signal 328 to create a voltage level. Furthermore, charge pump 312 increases the created voltage level to a level sufficient to power circuits of IC die 306. Charge pump 312 may also include a regulator to stabilize the voltage of tag power signal 326. Charge pump 312 may be configured in any suitable way known to persons skilled in the relevant art(s). For description of an example charge pump applicable to tag 102, refer to U.S. Pat. No. 6,734,797, titled “Identification Tag Utilizing Charge Pumps for Voltage Supply Generation and Data Recovery,” which is incorporated by reference herein in its entirety. Alternative circuits for generating power in a tag are also applicable to embodiments of the present invention. Further description of charge pump 312 is provided below.

It will be recognized by persons skilled in the relevant art(s) that tag 102 may include any number of modulators, demodulators, charge pumps, and antennas. Tag 102 may additionally include further elements, including an impedance matching network and/or other circuitry. Embodiments of the present invention may be implemented in tag 102, and in other types of tags. Furthermore, although tag 102 is shown in FIG. 3 as a passive tag, tag 102 may alternatively be an active tag (e.g., powered by battery).

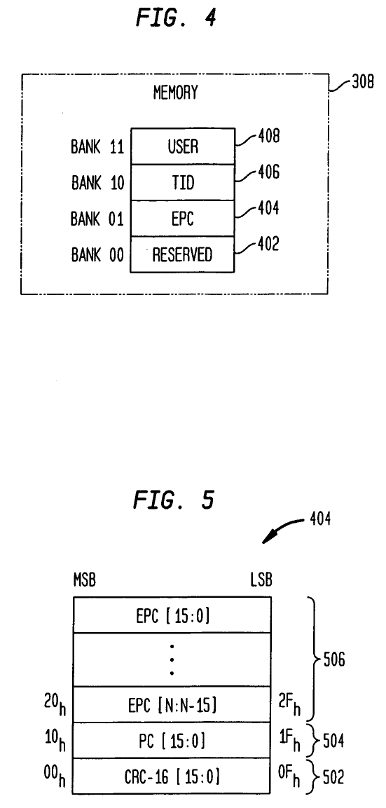

Memory 308 may have a variety of logical structures. FIG. 4 shows a logical representation of memory 308 in an example Gen 2-type RFID tag. As shown in FIG. 4, memory 308 is logically separated into first-fourth memory banks 402, 404, 406, and 408, each of which may store zero or more memory words.

First memory bank 402 may be referred to as “reserved memory” or “memory bank 00.” Memory bank 402 stores kill and access passwords. The access password is a 32-bit value stored in memory addresses 20hex to 3Fhex. A default (unprogrammed) value for the access password is zero. Tags with a nonzero access password require a reader to issue the access password before transitioning to a secured state. A tag that does not implement an access password operates as though it had a zero-valued access password that is permanently read/write locked.

Second memory bank 404 may be referred to as “EPC memory” or “memory bank 01.” FIG. 5 shows further detail of memory bank 404 in a Gen 2-type tag. In a first memory portion 502 at memory addresses 00hex to 0Fhex of memory bank 404, a 16 bit cyclic redundancy check (CRC) checksum (“CRC-16”) is stored. In a second memory portion 504 at memory addresses 10hex to 1Fhex of memory bank 404, Protocol-Control (PC) bits are stored. In a third memory portion 506 beginning at 20hex of memory bank 404, a code is stored (such as an electronic product code (EPC)) that identifies the object to which the tag is associated.

Third memory bank 406 may be referred to as “TID memory” or “memory bank 10.” Memory bank 406 stores an 8-bit ISO/IEC 15963 allocation class identifier (111000102 for EPCglobal) at memory locations 00hex to 07hex. Memory bank 406 further includes sufficient identifying information above 07hex for a reader to uniquely identify the custom commands and/or optional features that a tag supports.

Fourth memory bank 408 may be referred to as “user memory” or “memory bank 11.” Memory bank 408 stores user-specific data. The organization of memory bank 408 is user-defined.

Further description of memory banks 402-408 in a Gen 2-type tag can be found in “EPC™ Radio-Frequency Identity Protocols, Class-1 Generation-2 UHF RFID, Protocol for Communications at 860 MHz-960 MHz,” Version 1.0.9, EPCglobal, Inc., copyright 2004, dated Jan. 1, 2005, pages 1-94 (see section 6.3.2.1, pages 35 and 36), which is incorporated by reference herein in its entirety.

Embodiments described herein are applicable to all forms of tags, including tag “inlays” and “labels.” A “tag inlay” or “inlay” is defined as an assembled RFID device that generally includes an integrated circuit chip (and/or other electronic circuit) and antenna formed on a substrate, and is configured to respond to interrogations. A “tag label” or “label” is generally defined as an inlay that has been attached to a pressure sensitive adhesive (PSA) construction, or has been laminated, and cut and stacked for application. A “tag” is generally defined as a tag inlay that has been attached to another surface, or between surfaces, such as paper, cardboard, etc., for attachment to an object to be tracked, such as an article of clothing, etc.

Example embodiments of the present invention are described in further detail below. Such embodiments may be implemented in the environments, readers, and tags described above, and/or in alternative environments and alternative RFID devices. For example, embodiments of the present invention may be implemented with regard to pharmaceutical, defense, border control (e.g., passports), and other applications.

### Example Embodiments

The example embodiments described herein are provided for illustrative purposes, and are not limiting. The examples described herein may be adapted to any type of tag and reader. Further structural and operational embodiments, including modifications/alterations, will become apparent to persons skilled in the relevant art(s) from the teachings herein.

Methods, systems, and apparatuses for preventing unauthorized reading of identifying data stored in tags are described. Embodiments of the present invention may be implemented in a wide variety of types of tags, including Class 0, Class 1, and Gen 2 type tags.

In an example embodiment, an RFID tag is configured to be singulated without reading a portion or all of the tag identifying information stored on the tag. The tag is “read locked” (temporarily or permanently), not allowing an identification of the tag to be made but still allowing a system to recognize that the tag is in the RF field. Thus, such an embodiment addresses privacy and security concerns in applications such as an EAS (Electronic Article Surveillance) application.

In an example Gen 2 embodiment, an RFID tag is rendered unreadable by receipt of a custom read lock command and a passcode, which read lock the tag. This “read lock” state of the tag may be permanent or temporary. For example, in a temporary read lock condition, subsequent receipt of the custom read lock command and passcode allows the tag to be read for identifying information. The tag transitions from the temporary read lock condition back to a readable state.

In an embodiment, a state machine of the tag is configured to implement the read lock functionality, which is initiated by receipt of the read lock command. Thus, the tag state machine may include a “read lock” state, for example. The command may include a bit sequence custom to the tag. This unique custom command (and passcode) is issued by a reader.

The tag is not killed during a read lock. Currently, an RFID system must kill a tag in order to render the unique identification number of the tag inoperable (unreadable), which also completely disables the tag. Thus, after being killed, the tag is no longer detectable. In contrast, the read lock feature allows the tag to be detected but not uniquely identified. Thus, in an embodiment, the read lock feature enables the unique identification number of a tag to be unreadable, while the presence of the tag can still be detected, such as by reading non-identification-related data of the tag.

In an embodiment, the tag may be singulated by the reader during read lock, but the tag does not transmit its identification number (e.g., EPC bits in a Gen 2 embodiment). By singulating the tag, but without obtaining the identification number of the tag, the reader merely determines that a tag is in the RF field of the reader, without being able to identify the tag (and the item with which the tag is associated). For example, this may prevent a rouge reader from being able to identify a tag, and therefore the item/object associated with the tag, thereby providing a measure of security.

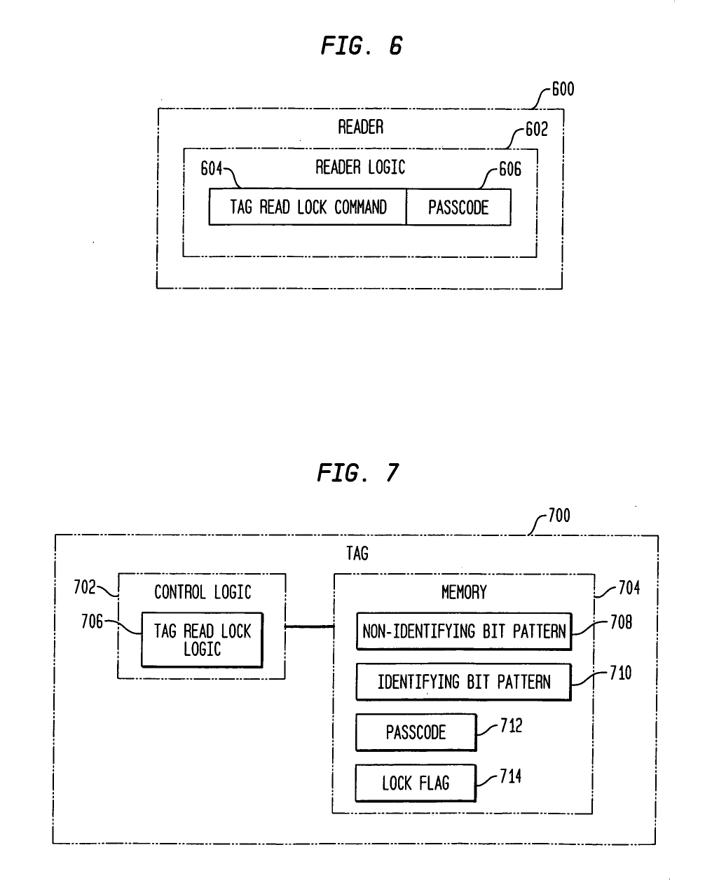

For example, FIG. 6 shows an example reader 600, according to an embodiment of the present invention. Reader 600 may be configured similarly to reader 104 described above, or in an alternative reader configuration. As shown in FIG. 6, reader 600 includes reader logic 602. Reader logic 602 is configured to transition a tag from a non-read lock state to a read lock state. In some embodiments, the read lock state is permanent for the tag. In other embodiments, the read lock state is not permanent. In a non-permanent read lock tag embodiment, reader logic 602 is further configured to transition the tag from the read lock state to a non-read lock state. As shown in FIG. 6, reader logic 602 generates a tag read lock command 604 and passcode 606. Reader 600 transmits read lock command 604 and passcode 606 to a tag to transition the tag from a non-read lock state to a read lock state, and to transition a tag in a read lock state to a non-read lock state (for a non-permanent read lock tag).

Reader logic 602 may include hardware, software, firmware, or any combination thereof to perform its functions. Reader logic 602 may be configured to be triggered to perform this function by an operator of reader 600, by a computer system coupled to reader 600, and/or in other manners, including any of the ways described elsewhere herein.

FIG. 7 shows a tag 700, according to an example embodiment of the present invention. Tag 700 may be configured similarly to tag 102 described above or in an alternative tag configuration, and may be configured to communicate according to Class 0, Class 1, Gen 2, and/or other present and/or future RFID communication protocols. Tag 700 is configured to transition from a non-read lock state to a read lock state when instructed to do so by a reader. For example, in an embodiment, tag 700 transitions from a non-read lock state to a read lock state after receiving read lock command 604 and passcode 606 from reader 600, where passcode 606 is a proper passcode for tag 700.

Refer to “EPC™ Radio-Frequency Identity Protocols, Class-1 Generation-2 UHF RFID, Protocol for Communications at 860 MHz-960 MHz,” Version 1.0.9, EPCglobal, Inc., copyright 2004, dated Jan. 1, 2005, pages 1-94 (hereinafter “Gen 2 Specification”) (see section 6.3.2.4, pages 39-41), for description of example tag states for a Gen 2 embodiment for tag 700.

As shown in FIG. 7, tag 700 includes control logic 702, which may be incorporated in control logic 310 described above with respect to FIG. 3, for example. Control logic 702 includes tag read lock logic 706. Tag read lock logic 706 is configured to transition tag 700 from a non-read lock state to a read lock state when instructed to do so by a reader, such as reader 600. In an embodiment, tag read lock logic 706 includes a state (e.g., a read lock state) in a state machine of control logic 702. In an embodiment, tag read lock logic 706 processes a received read lock command 604 and passcode 606 received from reader 600. Tag read lock logic 706 may include hardware, software, firmware, or any combination thereof to perform its functions.

As shown in FIG. 7, tag 700 further includes a memory 704, which may be memory 308 described above with respect to FIG. 3, for example. Memory 704 includes a non-identifying bit pattern 708, an identifying bit pattern 710, a passcode 712, and a lock flag 714.

Non-identifying bit pattern 708 may be any bit pattern used by a tag to respond to a reader to indicate the presence of the tag, without identifying the tag. Non-identifying bit pattern 708 may be a permanent bit pattern or may be periodically changed (e.g., regenerated). For example, non-identifying bit pattern 708 may be generated by a random number generator of tag 700. In a Gen 2 embodiment, non-identifying bit pattern 708 may be the RN16 value transmitted by a tag in response to a Query or other type command. Thus, in an embodiment, non-identifying bit pattern 708 may be transmitted by tag 700 to indicate the present of tag 700 (i.e., to singulate tag 700), but does not uniquely identify tag 700.

Identifying bit pattern 710 may be any bit pattern used by a tag to uniquely identify the tag (and to identify the item/object with which the tag is associated) to an entity, such as a reader. For example, in a Gen 2 embodiment, identifying bit pattern 710 may be any suitable portion or all of the CRC code, the PC bits, and/or the EPC code stored in EPC memory (memory bank 404 shown in FIGS. 4 and 5. Furthermore, identifying bit pattern 710 may include any suitable portion of data stored in user memory (memory bank 408 shown in FIG. 4) by a user that may be used to identify the tag (and/or an item with which the tag is associated), and/or any suitable data stored in other portions of memory that may be used to identify the tag (and/or the item/object).

Passcode 712 is a passcode for tag 700 used to enable read lock of tag 700. For example, as described above, tag read lock logic 706 is configured to process a received read lock command 604 and passcode 606 received from reader 600. FIG. 8 shows reader 600 transmitting read lock command 604 (with passcode 606) to tag 700. Tag read lock logic 706 determines whether read lock command 604 is received. If a read lock command 604 is received, tag read lock logic 706 accesses passcode 712 stored in memory 704 of tag 700, and compares passcode 606 received with read lock command 604 to passcode 712 stored in memory 704. If passcode 606 matches passcode 712, tag 700 transitions to a read lock state. For example, in an embodiment, memory 704 includes lock flag 714. Tag read lock logic 706 sets lock flag 714 to indicate that tag 700 is in a read lock state. Tag read lock logic 706 may alternatively use other means to indicate that tag 700 is in a read lock state.

In an embodiment, tag 700 does not acknowledge to reader 600 that tag 700 successfully transitioned to read lock state, or that tag 700 did not transition to read lock state, such as if tag read lock logic 706 determined that passcode 606 did not match passcode 712. In another embodiment, tag 700 transmits a response signal 802 to reader 600. If tag 700 successfully transitioned to read lock state, response signal 802 may include any indication of this, including transmitting non-identifying bit pattern 708 (e.g., RN16 in a Gen 2 embodiment) and/or other non-identifying bit pattern (e.g, a “1” bit/bits to indicate success). If tag 700 did not successfully transitioned to read lock state, response signal 802 may include any indication of this, including transmitting non-identifying bit pattern 708 (e.g., RN16 in a Gen 2 embodiment) and/or other non-identifying bit pattern (e.g, a “0” bit/bits to indicate failure).

In an example Gen 2 embodiment, passcode 712 may be the 32-bit access password in reserved memory (memory bank 402), or other previously defined passcode stored in a tag. Alternatively, passcode 712 may be a passcode present specifically for read locking.

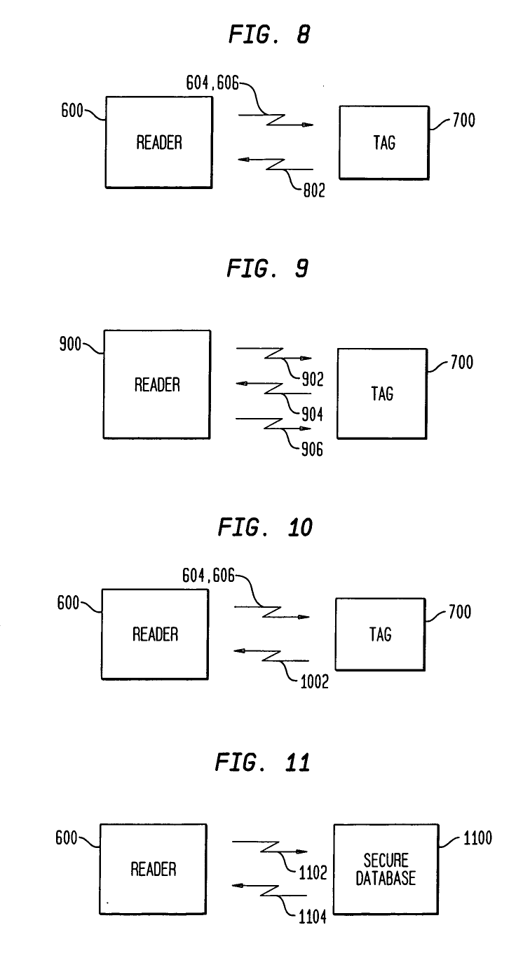

FIG. 9 shows communications with a reader 900 while tag 700 is in a read lock state, according to an embodiment of the present invention. As shown in FIG. 9, reader 900 transmits a first signal 902 to tag 700 to singulate tag 700 (if tag 700 was not previously singulated). For example, in a Gen 2 embodiment, first signal 902 may be a Query-type command.

As further shown in FIG. 9, tag 700 transmits a response signal 904 to reader 900, to indicate the presence of tag 700, without providing identifying information. For example, response signal 904 may include non-identifying bit pattern 708.

As still further shown in FIG. 9, reader 900 transmits a second signal 906 to tag 700, in an attempt to read identifying information from tag 700. For example, in a Gen 2 embodiment, second signal 906 may be a read command. However, as shown in FIG. 9, because tag 700 is in a read lock state, tag 700 does not respond to second signal 906. Alternatively, in an embodiment, tag 700 may respond to second signal 906 with non-identifying information, such as non-identifying bit pattern 708.

As described above, the read lock state for tag 700 may be permanent or temporary. For example, in a permanent read lock embodiment, when lock flag 714 is present and is set, it cannot be reset to transition tag 700 out of read lock (e.g., in a non-volatile memory of tag 700). Thus, in such a permanent state, the presence of tag 700 can be determined (e.g., non-identifying bit pattern 708 can be read from tag 700), but tag 700 cannot be uniquely identified (e.g., identifying bit pattern 710 cannot be read from tag 700).

In a temporary read lock embodiment, when tag 700 is in a read lock state, reader 600 may communicate with tag 700 to transition tag 700 to a non-read lock state. In an embodiment, reader 600 can cause tag 700 to toggle between read lock and non-read lock states. For example, FIG. 10 show reader 600 transmitting read lock command 604 (and passcode 606) to tag 700, which is in a read lock state. (Alternatively, a specific command different from read lock command 604 may be transmitted by reader 600 to transition tag 700 from read lock to a non-read lock state). Tag read lock logic 706 determines whether read lock command 604 is received. If a read lock command 604 is received, tag read lock logic 706 accesses passcode 712 stored in memory 704 of tag 700, and compares passcode 606 received with read lock command 604 to passcode 712 stored in memory 704. If passcode 606 matches passcode 712, tag 700 transitions to a non-read lock state. For example, in an embodiment, memory 704 includes lock flag 714. Tag read lock logic 706 resets lock flag 714 to indicate that tag 700 is in a non-read lock state. Tag read lock logic 706 may alternatively use other means to indicate that tag 700 is in a non-read lock state.

In an embodiment, tag 700 does not acknowledge to reader 600 that tag 700 successfully transitioned to non-read state, or that tag 700 did not transition to non-read lock state, such as if tag read lock logic 706 determined that passcode 606 did not match passcode 712. In another embodiment, tag 700 transmits a response signal 1002 to reader 600. If tag 700 successfully transitioned to non-read lock state, response signal 1002 may include any indication of this, including transmitting non-identifying bit pattern 708 (e.g., RN16 in a Gen 2 embodiment), other non-identifying bit pattern (e.g, a “1” bit/bits to indicate success), and/or may transmit identifying bit pattern 710. If tag 700 did not successfully transitioned to a non-read lock state, response signal 1002 may include any indication of this, including transmitting non-identifying bit pattern 708 (e.g., RN16 in a Gen 2 embodiment) and/or other non-identifying bit pattern (e.g, a “0” bit/bits to indicate failure).

Note that, as described above, a read lock state for tag 700 disables tag 700 from transmitting identifying information. In various embodiments, a variety of information stored in tag 700 may be disabled from being transmitted while in a read lock state. For example, any portion of, all of, or combination of the following data elements may be disabled from transmission in tag 700 when in a read lock state in a Gen 2 embodiment: EPC memory (memory bank 404), including first memory portion 502 (CRC checksum), second memory portion 504 (PC bits), and/or third memory portion 506 (EPC code); TID memory 406, such as the identifier; user memory (memory bank 408), such as any information stored in user memory that could uniquely identify the tag and/or an item/object with which the tag is associated. In one embodiment, a single read lock command may be used by reader 600 to lock memory in tag 700 from being read for identifying information. In another embodiment, a plurality of different read lock commands may be transmitted by reader 600, that each lock a particular predetermined portion of memory. In still another embodiment, a read command includes a memory parameter configured by reader 600 that designates which portion of memory of tag 700 is to be read locked by the command.

In an embodiment, reader 600 communicates with a secure database 1100 using a communications module (e.g., network interface 216 or other communications interface) (in a wired or wireless fashion), as shown in FIG. 11, to obtain one or more passcodes 712 for tags. As shown in FIG. 11, reader 600 transmits a passcode request 1102 to secure database 1100, which may include identifying information for one or more tags (e.g., identifying bit pattern 710). Secure database 1100 transmits a response signal 1104 to reader 600. Response signal 1104 includes one or more passcodes 712 corresponding to the tag identifying information received in passcode request 1102, that may be used to access and control read lock for one or more tags 700.

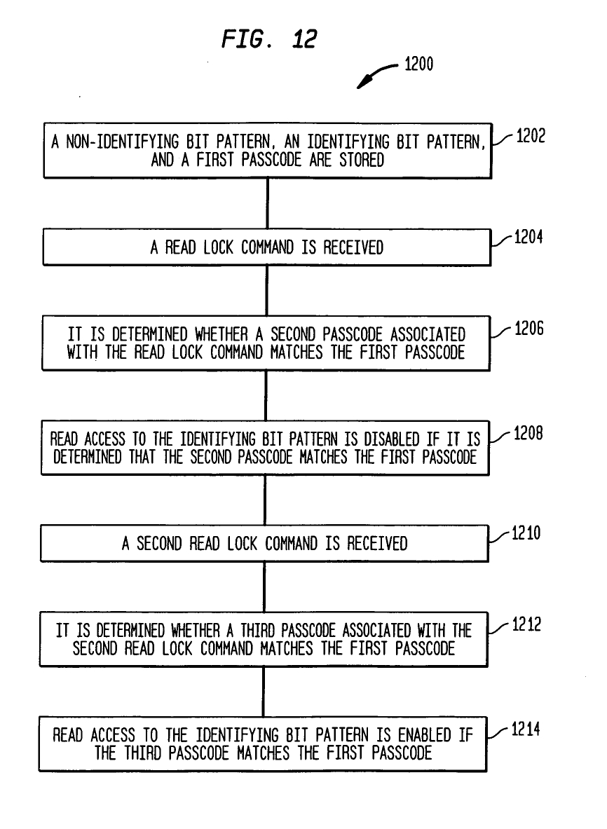

FIG. 12 shows a flowchart 1200 providing example steps for a tag to communicate with a reader, according to an example embodiment of the present invention. Other structural and operational embodiments will be apparent to persons skilled in the relevant art(s) based on the following discussion. The steps shown in FIG. 12 do not necessarily have to occur in the order shown. The steps of FIG. 12 are described in detail below.

Flowchart 1200 begins with step 1202. In step 1202, a non-identifying bit pattern, an identifying bit pattern, and a first passcode are stored. For example, the non-identifying bit pattern, identifying bit pattern, and first passcode are non-identifying bit pattern 708, identifying bit pattern 710, passcode 712 stored in tag 700.

In step 1204, a read lock command is received. For example, the read lock command is read lock command 604 received from reader 600, as shown in FIG. 8.

In step 1206, it is determined whether a second passcode associated with the read lock command matches the first passcode. For example, the second passcode is passcode 604, transmitted with (or after) read lock command 604.

In step 1208, read access to the identifying bit pattern is disabled if it is determined that the second passcode matches the first passcode. For example, read access to identifying bit pattern 710 is disabled by tag read lock logic 706 if it determines that passcode 606 does not match passcode 712.

Steps 1210, 1212, and 1214 are optional steps that may occur in a non-permanent read lock embodiment. In step 1210, a second read lock command is received. For example, a second read lock command 604 is received from reader 600.

In step 1212, it is determined whether a third passcode associated with the second read lock command matches the first passcode. For example, the third passcode is passcode 604, transmitted with (or after) read lock command 604 as shown in FIG. 10.

In step 1214, read access to the identifying bit pattern is enabled if the third passcode matches the first passcode. For example, read access to identifying bit pattern 710 is enabled by tag read lock logic 706 if it determines that passcode 606 matches passcode 712.

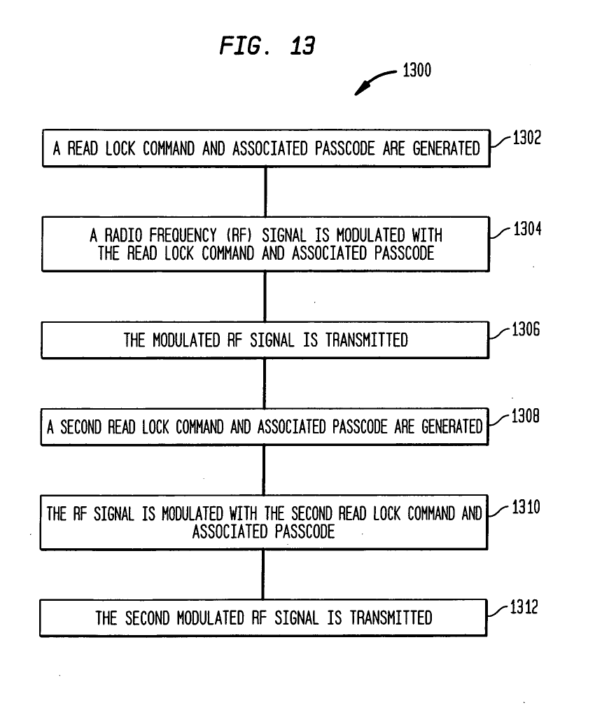

FIG. 13 shows a flowchart 1300 providing example steps for a reader to communicate with a tag, according to an example embodiment of the present invention. Other structural and operational embodiments will be apparent to persons skilled in the relevant art(s) based on the following discussion. The steps shown in FIG. 13 do not necessarily have to occur in the order shown. The steps of FIG. 13 are described in detail below.

Flowchart 1300 begins with step 1302. In step 1302, a read lock command and associated passcode are generated. For example, the read lock command and associated passcode are read lock command 604 and passcode 606 generated (e.g., formatted) by reader logic 602, as shown in FIG. 6.

In step 1304, a radio frequency (RF) signal is modulated with the read lock command and associated passcode. For example, modulator 208 shown in FIG. 2 modules an RF carrier signal with read lock command 604 and passcode 606, as data.

In step 1306, the modulated RF signal is transmitted. For example, the RF signal modulated with read lock command 604 is transmitted as shown in FIG. 8. A tag that receives the modulated RF signal is thereby caused to transition to a read lock state.

Steps 1308, 1310, and 1312 are optional steps that may occur in a non-permanent read lock embodiment. In step 1308, a second read lock command and associated passcode are generated. For example, the second read lock command and associated passcode are read lock command 604 and passcode 606 generated (e.g., formatted) by reader logic 602, as shown in FIG. 6.

In step 1310, the RF signal is modulated with the second read lock command and associated passcode. For example, modulator 208 shown in FIG. 2 modules an RF carrier signal with read lock command 604 and passcode 606, as data.

In step 1312, the second modulated RF signal is transmitted. For example, the RF signal modulated with read lock command 604 is transmitted as shown in FIG. 10. The tag receives the second modulated RF signal and is thereby caused to transition to a non-read lock state.

### Further Example Embodiments

This section provides further detailed example embodiments. The example embodiments described herein are provided for illustrative purposes, and are not limiting. The examples described herein may be adapted to any type of tag and reader, and to a variety of applications, including electronic goods, retail apparel, pharmaceuticals, identification cards, etc. Further structural and operational embodiments, including modifications/alterations, will become apparent to persons skilled in the relevant art(s) from the teachings herein.

The embodiments described herein provide levels of security for verification and authentication of tags (and thus for the item/object/product associated with the tag). RFID technology enables supply chains that are faster, less expensive, and more automated than ever before. Furthermore, RFID enables more top line sales to manufacturers by minimizing stock outs. While the increased benefits from automated data collection due to RFID technology are relatively clear to manufacturers, a potential for exposing privacy and/or for introducing counterfeit or fake products into the supply chain in an undetected manner is feared.

Current Gen 2 RFID systems are vulnerable to fraud due to the ease of being able to copy a product identification number (e.g., the EPC code) from a ‘valid’ RFID tag associated with a product, and transferring the identification number to a second tag by writing the identification number to the second tag using EPC Gen 2 compliant hardware.

This vulnerability allows for the creation of fraudulent tags to be applied to products that are not authentic, for the passing off of these products as valid product through a RFID enabled automated supply chain. Within current Gen 2 standards, a way to hide or protect tag data, enabling a manufacturer to encode authentication data into the tag and to securely validate that data throughout the life of the product, does not exist. Such an ability would eliminate concerns regarding duplicated tags, would provide a way for retailers to authenticate returned items, would provide a way to validate products, and would significantly improve customer privacy and ensure data integrity throughout a supply chain. Embodiments described herein provide for such abilities.

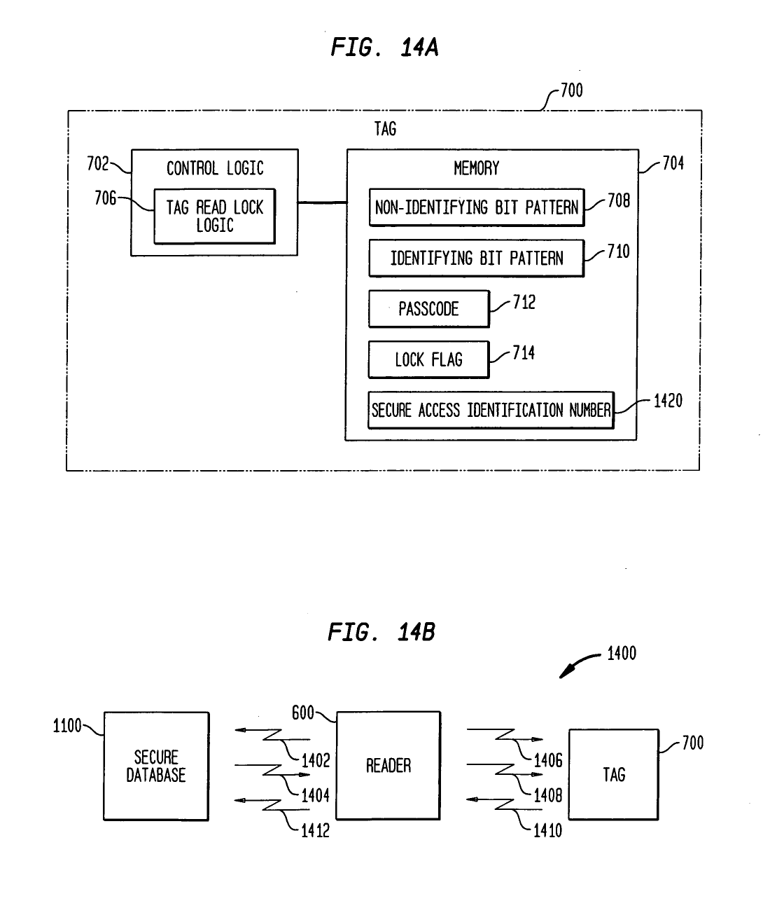

In an embodiment, a tag includes secure access identification number that can be used to determine a read lock password for the tag, as further described below. For example, FIG. 14A show tag 700, according to an embodiment of the present invention. As shown in FIG. 14A, tag 700 is generally similar to tag 700 shown in FIG. 7, except the tag 700 of FIG. 14A further includes a secure access identification number 1420. Secure access identification number 1420 is further described below.

FIG. 14B shows a system 1400 for securing data on a tag 700, according to an example embodiment of the present invention. As shown in FIG. 14B, system 1400 includes secure database 1100, reader 600, and tag 700. In embodiments, secure database 1100 and reader 600 may communicate over a wired or wireless medium. Various communication signals are shown in FIG. 14B for communications between secure database 1100, reader 600, and tag 700. Not all of these signals are required in all embodiments, and are provided for illustrative purposes.

As shown in FIG. 14B, reader 600 transmits a first signal 1402 to secure database 1100. Reader 600 transmits first signal 1402 to register with, or be certified for communications in the local environment (e.g., a reader network). Secure database 1100 receives and processes first signal 1402, to register reader 600.

Secure database 1100 transmits a second signal 1404 to reader 600. Second signal 1404 includes information for reader 600 to identify tags, and may include information to be written to tags as desired. For example, the information may include identifying bit pattern 710 (e.g., an EPC code, PC bits, CRC bits, and/or user defined data) and/or other information to be written to tags. Furthermore, second signal 1404 may include secure access identification number 1420 (secure access ID) also referred to as a “challenge identification number” (challenge ID). Furthermore, second signal 1404 may include passcode 606 to be stored in one or more tags. Each passcode 606 for a particular tag may be paired with a particular challenge ID. Reader 600 receives second signal 1404, and stores the received information.

Reader 600 transmits a third signal 1406 to tag 700. Using third signal 1406, reader writes information received from secure database 1100 in second signal 1404 to tag 700. Furthermore, the written data may be secured in tag 700 from being overwritten according to a secure access password (e.g., in a Gen 2 embodiment, in secured state in the above referenced Gen 2 specification, section 6.2.3.4.6), if desired. Third signal 1406 may further include secure access identification number 1420. The challenge ID does not uniquely identify the tag into which it is written. However, secure access identification number 1420 is stored in the tag, and can be read from the tag even in a read lock state. Secure access identification number 1420 can be mapped by secure database 1100 to a passcode 606 for the tag, to change the read lock state of the tag. Secure access identification number 1420 is stored in memory 704 of tag 700.

Reader 600 transmits a fourth signal 1408 to tag 700. Tag 700 receives and processes fourth signal 1408. Fourth signal 1408 includes read lock command 604 and associated passcode 606 to read lock tag 700 (i.e., transition tag 700 to a read lock state). As described above, when read locked, the presence of tag 700 can be detected (e.g., by singulation), but designated information cannot be retrieved from tag 700, such as identifying information and/or user defined information. The read lock may be permanent or temporary, as described above. Furthermore, the read lock may be for a predetermined portion of memory 704 of tag 700, or read lock command 604 may include parameters that dictate which portions of memory 704 are to be read locked (cannot be read). For example, in a Gen 2 embodiment, any portion or all of EPC memory (memory bank 404) and/or user memory (memory bank 408) may be read locked, which may be determined by read lock command 604, or may be predetermined.

Tag 700 transmits a fifth signal 1410 to reader 600. Fifth signal 1410 is an acknowledgment signal from tag 700, received by reader 600, to acknowledge that read lock was successful (or unsuccessful).

Reader 700 transmits a sixth signal 1412 to secure database 1100. Sixth signal 1412 is received by secure database 1100. Sixth signal 1412 can have various functions, including updating secure database 1100 with an indication that tag 700 has been read locked, what data has been stored/locked in tag 700 (e.g., the value of passcode 606), etc.

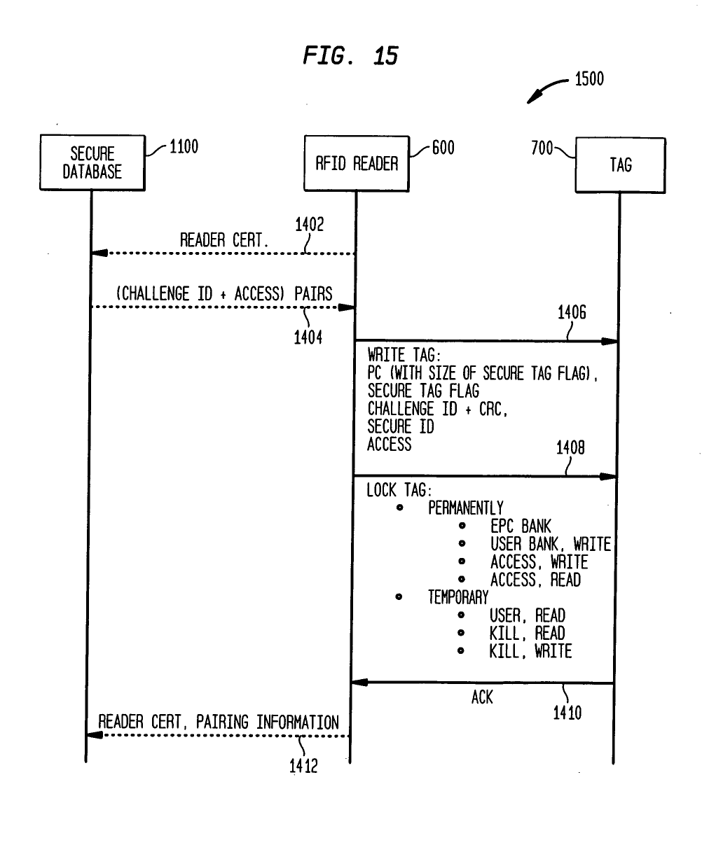

FIG. 15 shows a ladder diagram 1500 showing additional detail for an example implementation of system 1400 of FIG. 14B, according to an embodiment of the present invention. Ladder diagram 1500 shows a sequence of communications, and example data communicated between secure database 1100, reader 600, and tag 700.

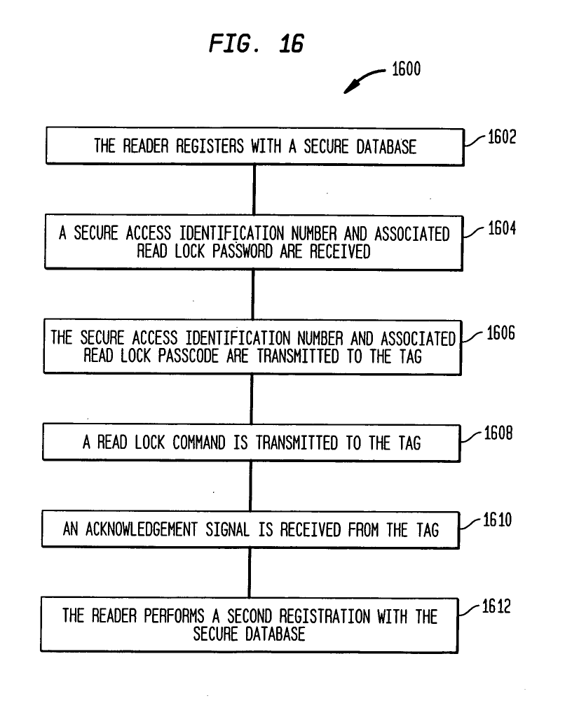

FIG. 16 shows a flowchart 1600 for a reader to configure a radio frequency identification (RFID) tag for read security, according to an example embodiment of the present invention. For example, flowchart 1600 may be implemented in system 1400 and/or with ladder diagram 1500 described above, or in another environment. Other structural and operational embodiments will be apparent to persons skilled in the relevant art(s) based on the following discussion. The steps of FIG. 16 are described in detail below.

Flowchart 1600 begins with step 1602. In step 1602, the reader registers with a secure database. For example, the reader transmits first signal 1402 shown in FIG. 14B to register with secure database 1100.

In step 1604, a secure access identification number and associated read lock password are received. For example, the secure access identification number and read lock password are received in second signal 1404 shown in FIG. 14B.

In step 1606, the secure access identification number (challenge ID) and associated read lock passcode are transmitted to the tag. For example, the secure access identification number and read lock password are transmitted in third signal 1406 shown in FIG. 14B.

In step 1608, a read lock command is transmitted to the tag. For example, the read lock command is transmitted in fourth signal 1408 shown in FIG. 14B.

In step 1610, an acknowledgment signal is received from the tag. For example, the acknowledgement signal is received in fifth signal 1410 shown in FIG. 14B.

In step 1612, the reader performs a second registration with the secure database. For example, the reader transmits sixth signal 1412 shown in FIG. 14B to again register with secure database 1100.

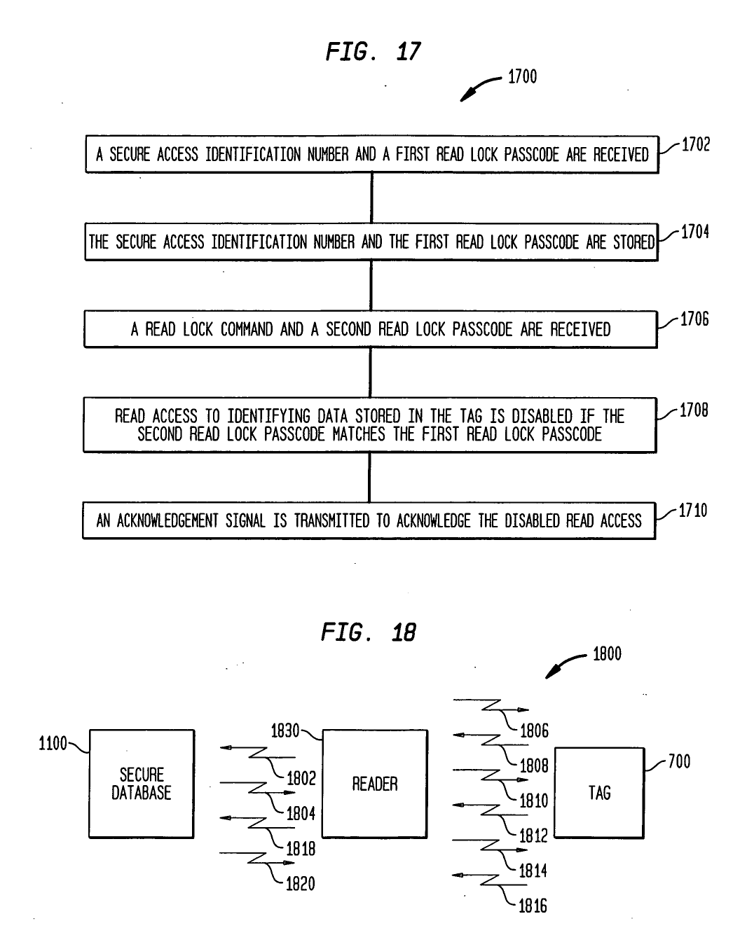

FIG. 17 shows a flowchart 1700 for a radio frequency identification (RFID) tag to be configured for read security, according to an example embodiment of the present invention. For example, flowchart 1700 may be implemented in system 1400 and/or with ladder diagram 1500 described above, or in another environment. Other structural and operational embodiments will be apparent to persons skilled in the relevant art(s) based on the following discussion. The steps of FIG. 17 are described in detail below.

Flowchart 1700 begins with step 1702. In step 1702, a secure access identification number and a first read lock passcode are received. For example, the secure access identification number and read lock password are received in third signal 1406 shown in FIG. 14B.

In step 1704, the secure access identification number and the first read lock passcode are stored. For example, as described above, the secure access identification number and first read lock password may be stored in memory 704 of tag 700. The secure access identification number may be stored as secure access identification number 1420, and the first read lock password may be stored as passcode 712.

In step 1706, a read lock command and a second read lock passcode are received. For example, the read lock command and second read lock passcode may be received in fourth signal 1408 shown in FIG. 14B. The read lock command may be read lock command 604, and the second read lock passcode may be passcode 606.

In step 1708, read access to identifying data stored in the tag is disabled if the second read lock passcode matches the first read lock passcode. For example, as described above, read access to identifying bit pattern 710 is disabled by tag read lock logic 706 if it determines that passcode 606 matches passcode 712.

In step 1710, an acknowledgment signal is transmitted to acknowledge the disabled read access. For example, the acknowledgement signal may be transmitted as fifth signal 1410.

FIG. 18 shows a system 1800 for communicating with a read locked tag, according to an example embodiment of the present invention. As shown in FIG. 18, system 1800 includes secure database 1100, a reader 1830, and tag 700. Various communication signals are shown in FIG. 18 for communications between secure database 1100, reader 1830, and tag 700. Not all of these signals are required in all embodiments, and are provided for illustrative purposes.

In an embodiment, as shown in FIG. 18, reader 1830 transmits a first signal 1802 to secure database 1100, and secure database 1100 transmits a second signal 1804 to reader 1830. Alternatively, in another embodiment as described further below, first and second signals 1802 and 1804 are transmitted after communications occur between reader 1830 and tag 700. The embodiment where first and second signals 1802 and 1804 are transmitted prior to communications between reader 1830 and tag 700 is described as follows.

Reader 1830 transmits a first signal 1802 to, secure database 1100. Reader 1830 transmits first signal 1802 to register with, to be certified for communications in the local environment (e.g., a reader network), or for other reason. Secure database 1100 receives and processes first signal 1802, to register reader 1830.

Secure database 1100 transmits a second signal 1804 to reader 1830. Second signal 1804 includes one or more passcodes (e.g., passcodes 606) and associated secure access identification numbers (challenge IDs) for reader 1830 to use to read lock/unlock one or more tags. Reader 1830 receives second signal 1804, and stores the passcodes and challenge IDs.

Reader 1830 transmits a third signal 1806 to tag 700. Third signal 1806 is received by tag 700, and is used to singulate tag 700.

Tag 700 transmits a fourth signal 1808 to reader 1830. For example, tag 700 transmits fourth signal 1808 to indicate its presence to reader 1830, without providing identifying information (for singulation purposes). For example, fourth signal 1808 may include all or a portion of non-identifying bit pattern 708. Reader 1830 receives fourth signal 1808.

Reader 1830 transmits a fifth signal 1810 to tag 700. Fifth signal 1810 includes a request for the secure access identification number stored in memory 704 of tag 700. Tag 700 accesses memory 704 to retrieve the secure access identification number.

Tag 700 transmits a sixth signal 1812 to reader 1830. Reader 1830 receives sixth signal 1812. Sixth signal 1812 includes the secure access identification number of tag 700.

In the current embodiment, where reader 1830 received passcodes and associated secure access identification numbers from secured database in signals 1802 and 1804, reader 1830 may use the secure access identification number received from tag 700 in signal 1812 to obtain the passcode of tag 700. Alternatively, as described above, in an embodiment, first and second signals 1802 and 1804 may be transmitted after communications occur between reader 1830 and tag 700 (e.g., after signals 1806, 1808, 1810, 1812). In such an embodiment, reader 1830 may transmit first signal 1802 to secure database 1100, where first signal 1802 includes the secure access identification number received from tag 700. Secure database 1100 receives first signal 1802 with the secure access identification number, determines the appropriate passcode associated with the secure access identification number, and transmits the passcode to reader 1830 in second signal 1804.

Reader 1830 transmits a seventh signal 1814 to tag 700. Seventh signal 1814 includes read lock command 604 and the passcode received from reader 1830 associated with the secure access identification number of tag 700 (e.g., passcode 606). As described above, upon receipt of the read lock command 604 and passcode 606, tag 700 may change states from read lock to a non-read lock state.

Tag 700 transmits an eighth signal 1816 to reader 1830. Eighth signal 1816 includes data of tag 700 that was previously read locked. For example, the data may be identifying bit pattern 710, including any of the lockable data described elsewhere herein. Eighth signal 1816 is received by reader 1830.

Reader 700 transmits a ninth signal 1818 to secure database 1100. Ninth signal 1818 is received by secure database 1100. Ninth signal 1818 may include the data of tag 700 provided in eighth signal 1816. Secure database 1100 processes ninth signal 1818 (e.g., to register reader 700, store/analyze/process the data from tag 700, etc.).

Secure database 1100 transmits a tenth signal 1820 to reader 1830. Tenth signal 1820 is received by reader 1830. Tenth signal 1820 provides information to reader 1830. The information may be used by reader 1830, an operator of reader 1830, or other entity, to further interact with tag 700, if desired.

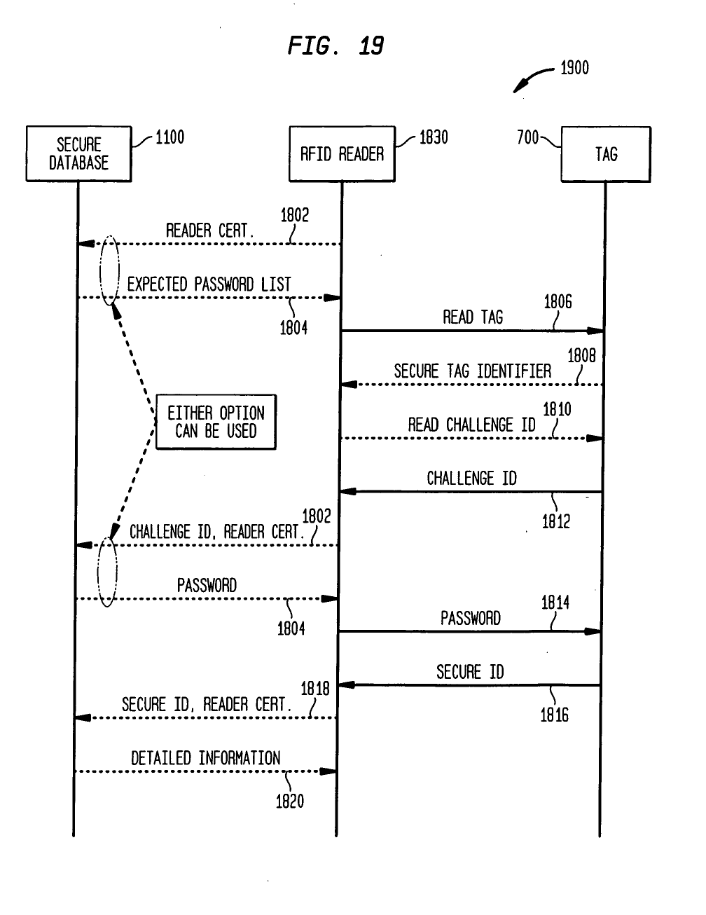

FIG. 19 shows a ladder diagram 1900 showing additional detail for an example implementation of system 1800 of FIG. 18, according to an embodiment of the present invention. Ladder diagram 1900 shows example sequences of communications, and example data communicated between secure database 1100, reader 600, and tag 700.

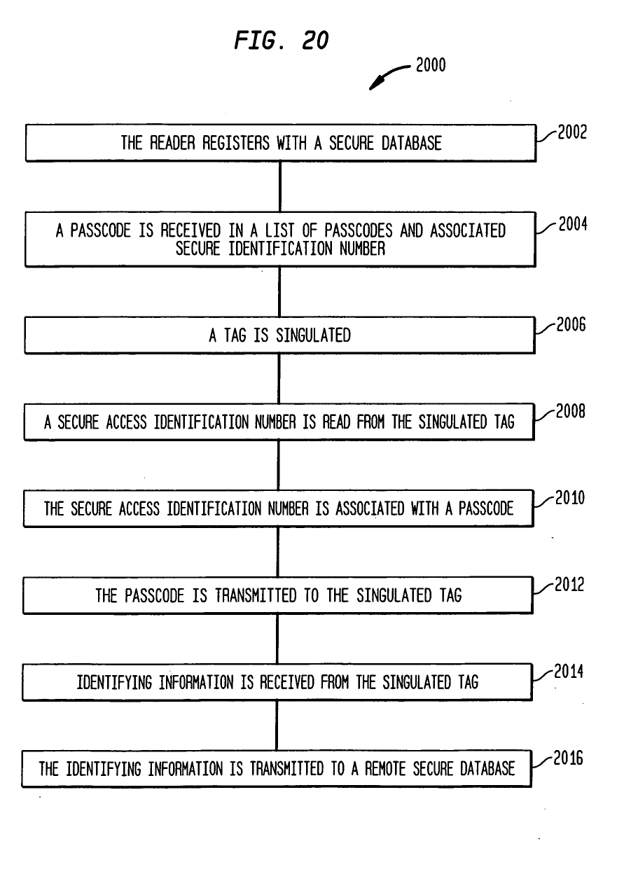

FIG. 20 shows a flowchart 2000 for communicating with a radio frequency identification (RFID) tag in a read lock condition, according to an example embodiment of the present invention. For example, flowchart 2000 may be implemented in system 1800 and/or with ladder diagram 1900 described above, or in another environment. Other structural and operational embodiments will be apparent to persons skilled in the relevant art(s) based on the following discussion. The steps of FIG. 20 are described in detail below.

Flowchart 2000 begins with step 2002. As described above, steps 2002 and 2004 are optional. In step 2002, the reader registers with a secure database. For example, the reader transmits first signal 1802 shown in FIG. 18 to register with secure database 1100.

In step 2004, a passcode is received in a list of passcodes and associated secure identification numbers. For example, the passcode list and associated secure identification numbers are received in second signal 1804 shown in FIG. 18.

In step 2006, a tag is singulated. For example, the reader may transmit third signal 1806 shown in FIG. 18 to the tag as a command to read the tag. Furthermore, the reader may receive a response in fourth signal 1808 to the read command from the tag, enabling the tag to be singulated.

In step 2008, a secure access identification number is read from the singulated tag. For example, the reader may transmit fifth signal 1810 shown in FIG. 18 to read a secure access identification number from the tag. The secure access identification number is received from the tag in sixth signal 1812.

In step 2010, the secure access identification number is associated with a passcode. For example, the secure access identification number may be transmitted to a remote secure database in first signal 1802 shown in FIG. 18 after step 2008, for the secure database to determine the passcode. The passcode associated with the secure access identification number may be received from the remote secure database in second signal 1804. Alternatively, the passcode associated with the secure access identification number may be determined from the list of passcodes optionally received in second signal 1804 in step 2004.

In step 2012, the passcode is transmitted to the singulated tag. For example, the passcode is transmitted to the tag in seventh signal 1814. The passcode is intended to unlock the tag to enable read access to identifying information.

In step 2014, identifying information is received from the singulated tag. For example, the identifying information is received in eighth signal 1816.

In step 2016, the identifying information is transmitted to a remote secure database. For example, the identifying information to transmitted in ninth signal 1818.

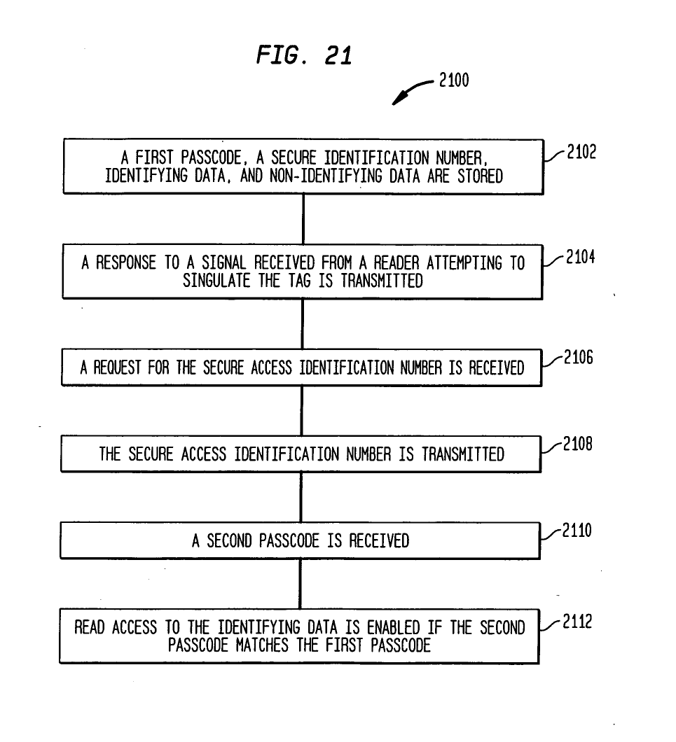

FIG. 21 shows a flowchart 2100 in a tag for reading the tag, according to an example embodiment of the present invention. For example, flowchart 2100 may be implemented in system 1800 and/or with ladder diagram 1900 described above, or in another environment. Other structural and operational embodiments will be apparent to persons skilled in the relevant art(s) based on the following discussion. The steps of FIG. 21 are described in detail below.

Flowchart 2100 begins with step 2102. In step 2102, a first passcode, a secure access identification number, identifying data, and non-identifying data are stored. For example, the first passcode, secure access identification number, identifying data, and non-identifying data are stored in memory 704 of tag 700 shown in FIG. 7.

In step 2104, a response to a signal received from a reader attempting to singulate the tag is transmitted. For example, the response is transmitted as fourth signal 1808 shown in FIG. 18.

In step 2106, a request for the secure access identification number is received. For example, the request is received as fifth signal 1810 shown in FIG. 18.

In step 2108, the secure access identification number is transmitted. For example, the secure access identification number is transmitted as sixth signal 1812 shown in FIG. 18.

In step 2110, a second passcode is received. For example, the second passcode is received in seventh signal 1814.

In step 2112, read access to the identifying data is enabled if the second passcode matches the first passcode. For example, read access to identifying data stored in the tag is enabled if the second passcode received in seventh signal 1814 matches the passcode stored in memory of the tag (e.g., the first passcode mentioned in step 1202).

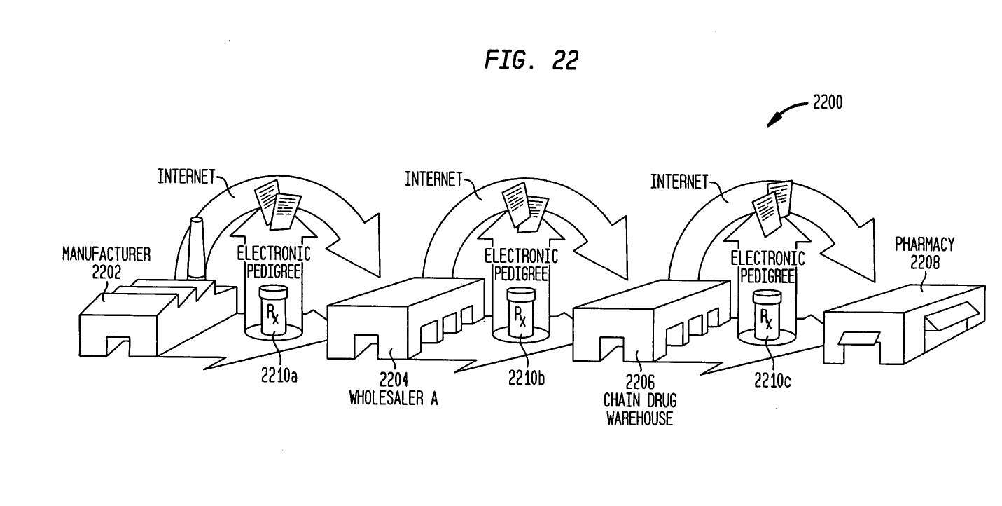

As described above, embodiments of the present invention are applicable to many environments and applications. For instance, FIG. 22 shows an example pharmaceutical environment 2200 implementing read security, according to an embodiment of the present invention. As shown in FIG. 22, pharmaceutical environment 2200 includes a manufacturer entity 2202, a wholesaler entity 2204, a chain drug warehouse entity 2206, and a pharmacy entity 2208. A pharmaceutical product 2210 is produced at manufacturer entity 2202, and is shown as pharmaceutical product 2210a output by manufacturer entity 2202. Pharmaceutical product 2210a may be a container that houses a plurality of pills, capsules, or other type of drug/pharmaceutical. Pharmaceutical product 2210a moves through the supply chain of pharmaceutical environment 2200, from manufacturer entity 2202 to wholesaler entity 2204 (shown at wholesaler entity 2204 as pharmaceutical product 2210b), to chain drug warehouse entity 2206 (shown at chain drug warehouse entity 2206 as pharmaceutical product 2210c), and finally to pharmacy entity 2208.

Pharmaceutical product 2210a has an associated (e.g., attached) RFID tag (not shown in FIG. 22) that stores user information and identifying information (e.g., an identification number, an EPC code, etc.). The identifying information can be used to identify pharmaceutical product 2210a and its contents. The user information may include private information (e.g., information about a customer to receive pharmaceutical product 2210) and/or further user-specified identifying information for the tag/item/item contents. For purposes of security and/or privacy, it may be desired that the identifying information and/or user information not be accessible during at least a portion of the movement of pharmaceutical product 2210 through pharmaceutical environment 2200. In this manner, pharmaceutical product 2210 can move through the supply chain without its contents and/or without the user information being known.

Thus, in an embodiment, at manufacturer entity 2202, pharmaceutical product 2210a can be read locked from reading of the identifying/user information. For example, in an embodiment, at least a portion of the steps of flowchart 1600 (FIG. 16) and/or flowchart 1700 (FIG. 17) can be performed to encode the tag of pharmaceutical product 2210a with a secure access identification number and password (e.g., step 1606, steps 1702 and 1704), and the tag can be read locked (e.g., step 1608, steps 1706 and 1708), so that user information stored in the tag cannot be accessed. The secure access identification number and password associated with pharmaceutical product 2210 may also be stored in a secure database for future access. For example, a secure database/network, such as provided by VeriSign Inc. of Mountain View, Calif., can be used for secure data handling and/or storage, including encryption.

As shown in FIG. 22, pharmaceutical product 2210 is transferred to wholesaler entity 2204 (shown as pharmaceutical product 2210b) and further to chain drug warehouse 2206 (shown as pharmaceutical product 2210c). However, at wholesaler entity 2204 and chain drug warehouse 2206, the tag of pharmaceutical product 2210 remains in read lock. Because the tag is in read lock, the user information cannot be read from the tag, although other information can be read from the tag. For example, in an embodiment, identifying information such as the EPC code can be read from the tag (e.g., in a Gen 2 tag), so that tag can be authenticated/identified (e.g., the “electronic pedigree” of the tag/item can be ascertained). In this manner, pharmaceutical product 2210 can be tracked and verified (e.g., in time, location) as it moves through environment 2200. However, the user information cannot be read from the tag due to the read lock, a measure of privacy for the user information.

At pharmacy entity 2208, the tag of pharmaceutical product 2210 can be read unlocked. For example, at least a portion of the steps of flowchart 2000 (FIG. 20) and/or flowchart 2100 (FIG. 21) can be performed to read unlock the tag (e.g., steps 2008-2012, steps 2106-2112), and to read the user information from the tag (e.g., step 2014). The secure database can be accessed as needed to associate a passcode with the tag (e.g., steps 2002, 2004, 2010). In this manner, the user information stored in the tag can be obtained at pharmacy entity 2208, where it may be used to aid in dispensing pharmaceutical product 2210.

### Example Computer System Embodiments

In this document, the terms “computer program medium” and “computer usable medium” are used to generally refer to media such as a removable storage unit, a hard disk installed in hard disk drive, and signals (i.e., electronic, electromagnetic, optical, or other types of signals capable of being received by a communications interface). These computer program products are means for providing software to a computer system. The invention, in an embodiment, is directed to such computer program products.

In an embodiment where aspects of the present invention are implemented using software, the software may be stored in a computer program product and loaded into a computer system using a removable storage drive, hard drive, or communications interface. The control logic (software), when executed by a processor, causes the processor to perform the functions of the invention as described herein.

According to an example embodiment, a reader may execute computer-readable instructions to communicate with a tag to transition the tag into and out of a read lock state. Furthermore, a reader may execute computer-readable instructions to communicate with a secure database, and a secure database may execute computer-readable instructions to communicate with a reader, as described above.

### Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method in a reader for configuring a radio frequency identification (RFID) tag for read security, comprising:
receiving a secure access identification number and associated read lock password;
transmitting the secure access identification number and associated read lock passcode to the tag;
transmitting a read lock command to the tag; and
receiving an acknowledgment signal from the tag.

2. The method of claim 1, wherein said transmitting the read lock command to the tag comprises transmitting the read lock passcode with the read lock command to the tag.

3. The method of claim 1, further comprising:
transmitting identifying information to the tag prior to said step of transmitting the read lock command to the tag.

4. The method of claim 1, further comprising:
transmitting user information to the tag prior to said step of transmitting the read, lock command to the tag.

5. A system in a reader for configuring a radio frequency identification (RFID) tag for read security, comprising:
means for receiving a secure access identification number and associated read lock password;
means for transmitting the secure access identification number and associated read lock passcode to the tag;
means for transmitting a read lock command to the tag; and
means for receiving an acknowledgment signal from the tag.

6. A method in a reader for reading data from a radio frequency identification (RFID) tag, comprising:
singulating a tag;
reading a secure access identification number from the singulated tag;
associating the secure access identification number with a passcode;
transmitting the passcode to the singulated tag; and
receiving information from the singulated tag.

7. The method of claim 6, wherein said receiving step comprises:
receiving user information from the singulated tag.

8. The method of claim 6, wherein said receiving step comprises:
receiving identifying information from the singulated tag.

9. The method of claim 6, further comprising:
receiving the passcode in a list of passcodes and associated secure identification numbers prior to said step of singulating the tag.

10. The method of claim 6, wherein said associating step comprises:
transmitting the read secure access identification number to a remote secure database; and
receiving the passcode associated with the read secure access identification number from the remote secure database.

11. The method of claim 6, further comprising:
transmitting the received information to a remote secure database.

12. The method of claim 11, further comprising:
receiving further information associated with the tag from the remote secure database.

13. The method of claim 12, further comprising:
interacting with an item associated with the tag based on the further information.

14. A system in a reader for reading data from a radio frequency identification (RFID) tag, comprising:
means for singulating a tag;
means for reading a secure access identification number from the singulated tag;
means for associating the secure access identification number with a passcode;
means for transmitting the passcode to the singulated tag; and
means for receiving information from the singulated tag.

15. A method in a radio frequency identification (RFID) tag for read security, comprising:
receiving a secure access identification number and a first read lock passcode;
storing the secure access identification number and the first read lock passcode;
receiving a read lock command and a second read lock passcode; and
disabling read access to data stored in the tag if the second read lock passcode matches the first read lock passcode.

16. The method of claim 15, further comprising:
transmitting an acknowledgment signal to acknowledge the disabled read access.

17. The method of claim 15, wherein said disabling step comprises:
disabling read access to user information stored in the tag if the second read lock passcode matches the first read lock passcode.

18. The method of claim 15, wherein said disabling step comprises:
disabling read access to identifying information stored in the tag if the second read lock passcode matches the first read lock passcode.

19. A system in a radio frequency identification (RFID) tag for read security, comprising:
means for receiving a secure access identification number and a first read lock passcode;
means for storing the secure access identification number and the first read lock passcode;
means for receiving a read lock command and a second read lock passcode; and
means for disabling read access to data stored in the tag if the second read lock passcode matches the first read lock passcode.

20. A method in a radio frequency identification (RFID) tag, comprising:
storing a first passcode, a secure access identification number, identifying information, and non-identifying information;
transmitting a response to a signal received from a reader attempting to singulate the tag;
receiving a request for the secure access identification number;
transmitting the secure access identification number;
receiving a second passcode; and
enabling read access to the identifying information if the second passcode matches the first passcode.

21. The method of claim 20, further comprising:
transmitting the identifying information.

22. The method of claim 20, wherein said transmitting a response comprises:
transmitting the non-identifying information.

23. A system in a radio frequency identification (RFID) tag, comprising:
means for storing a first passcode, a secure access identification number, identifying information, and non-identifying information;
means for transmitting a response to a signal received from a reader attempting to singulate the tag;
means for receiving a request for the secure access identification number;
means for transmitting the secure access identification number;
means for receiving a second passcode; and
means for enabling read access to the identifying information if the second passcode matches the first passcode.
